(19) United States
(12) Patent Application Publication
(10) Pub. No.: US 2007/0134372 A1
(43) Pub. Date: Jun. 14, 2007

(54) Method of producing ethanol

(75) Inventors: Alexander Alexandrovich Ezhkov, Moscow (RU); Alexander Viktorovich Ezhkov, Moscow (RU); Dmitri Viktorovich Arsenjev, Brest (BY); Anatoli Fedorovich Tsytsarkin, Moscow (RU)

Correspondence Address: HOUSTON ELISEEVA, 4 MILITIA DRIVE, SUITE 4, LEXINGTON, MA, 02421, US

(73) Assignee: NPK EKOLOGIA, New York, NY (US)

(21) Appl. No.: 11/427,004

(22) Filed: Jun. 28, 2006

(30) Foreign Application Priority Data
Dec. 12, 2005 (RU) 2005138380

(51) Int. Cl. C12C 11/00

(52) U.S. Cl. 426/11

(57) ABSTRACT

The present invention concerns to the distillation industry and can be used in units for production of rectified alcohol. The technical result on the achievement of which the present invention is directed consists in power consumption decrease. Fresh wort and yeast are supplied to the preparatory vessel 1 through the line 2 and the branch pipe 3 correspondingly in a demanded proportion. As a result the fermentation of wort begins and initial beer is formed. The working temperature and consistence of initial beer is provided by the stirrer 4 and heat exchanger 5, and then it is directed to the working section 6. The process of fermentation and emission of ethanol proceeds in the initial beer in the working section 6. Simultaneously with the process of fermentation the carbon dioxide, ethanol and water vapours is carried out through the vacuum line 7 and the further beer fermentation occurs at the lowered pressure. Not fully fermented beer is brought out from section 6 and supply to decanter 8. The choice of value of the remained ethanol in beer in each particular case is influenced with many factors such as: quality of yeast, physical and chemical parameters of beer itself, operating conditions of ethanol stripping etc; the criteria are quantity of physiologically active yeast in not fully fermented beer and power consumption on removal of the remained ethanol. Separation of centrifuge effluent from the deposit is carried out in the decanter 8 and concentration of active yeast in centrifuge effluent and concentration of dry substances in the deposit is raised thereby. The deposit with already great value of the dry substances content goes on technological purpose and centrifuge effluent is supplied into the storage tank 9 and further goes to preparatory vessel through the return circuit 10.

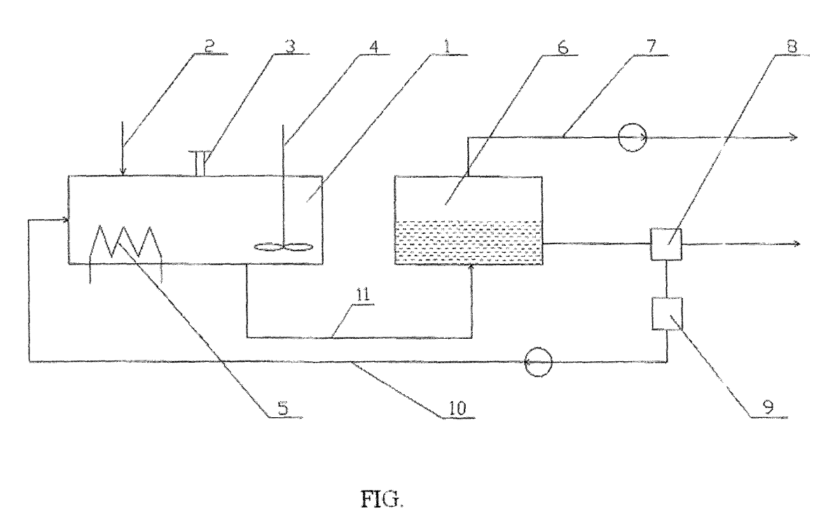

### RELATED APPLICATIONS

This application claims priority to Russian application serial number 2005138380 filed on Dec. 12, 2005, which is incorporated herein by reference in its entirety.

### FIELD OF THE INVENTION

The field of invention is distillation industry; the invention can be used in the units (plants) to obtain rectified alcohol.

### BACKGROUND OF THE INVENTION

The method of producing ethanol, including the stage of the beer preparation, the heating stage and the stage of ethanol emission with subsequent exhausted beer drain is known (RU, No. 2100043 C1, 1997).

The disadvantage of the above technical decision is complexity of the process equipment and significant energy consumption connected with it.

The method of producing ethanol accepted as the nearest analogous method comprising the stage of beer preparation, its heating and effected at the low pressure continuous fermentation and continuous steam and carbon dioxide stripping with the subsequent drain of exhausted beer and return of the part of it to the stage of initial beer preparation (RU, No. 2230788 C2, 2004).

### SUMMARY OF THE INVENTION

In the above technical decision feed of yeast stops after filling technological capacities with initial beer and instead of it a part of exhausted beer is brought to the wort containing physiologically active yeast cells which cause the fresh wort fermentation and the continuation of producing ethanol thereby.

Since the concentration of physiologically active yeast cells in the exhausted beer is considerably lowered, the big content of dry substances in the initial beer is supported forcedly for the achievement of their demanded relative quantity necessary for fresh wort fermentation.

The disadvantage of the specified technical decision is the great value of the content of dry substances in initial beer what leads to significant energy consumption at all stages of a technological chain of its processing.

The technical effect of the invention is directed to the energy consumption decrease.

The specified technical effect is reached by that in a way of reception of producing ethanol, comprising a stage of initial beer preparation, its heating and continuous fermentation and continuous stripping of hydroalcoholic vapours and carbon dioxide carried out at the lowered pressure with the subsequent tap of exhausted beer and return of its part to the stage of initial beer preparation, during tap the beer being subjected by decantation with centrifuge effluent fermentation and formed centrifuge effluent is directed to the stage of initial beer preparation.

Besides the content of ethanol in the beer is monitored during stripping and the beer is tapped after achievement of ethanol value by less than 0.5%.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawing, reference characters refer to the same parts throughout the different views. The drawing is not necessarily to scale; emphasis has instead been placed upon illustrating the principles of the invention.

The invention is explained by the drawing on which the unit implementing a way of producing ethanol is schematically represented.

### DETAILED DESCRIPTION OF THE PREFERRED EMBODIMENTS

The unit comprising the preparatory vessel 1 in which initial beer preparation is carried out by mixing the fresh wort which is brought through the line 2 with yeast coming in through the branch pipe 3. The preparatory vessel 1 comprises the stirrer 4 and the heat exchanger 5 and is connected by means of the pipeline 11 to working section 6 which is partially filled with beer and supplied by a vacuum line of vapour collection 7. The decanter 8 is connected to the liquid cavity of section 6 and supplied by the centrifuge effluent storage tank 9. The storage tank 9 is connected to the preparatory vessel 1 by the return circuit 10.

The stirrer 4, heat exchanger 5 and decanter 8 can be made by any known way under each particular case.

The method is carried out as follows.

Fresh wort and yeast are supplied to the preparatory vessel 1 through the line 2 and the branch pipe 3 correspondingly in a demanded proportion. As a result the wort fermentation is started and initial beer is formed. Thus the content of dry substances in the beer is selected out of a condition of optimum work of the process equipment. The working temperature and consistence of initial beer is provided by the stirrer 4 and heat exchanger 5, then it is directed to the working section 6. The process of fermentation and release of ethanol proceeds in the initial beer in the working section 6. Simultaneously with the process of fermentation the carbon dioxide, ethanol and water vapours is carried out through the vacuum line 7 and the further beer fermentation occurs at the lowered pressure. Because of duly removal of yeast life activity products such as alcohol and carbon dioxide being inhibitors of the alcohol fermentation process there is no alcohol and carbon dioxide accumulation in beer therefore the process of producing ethanol is intensified. The content of ethanol in beer is monitored during stripping of vapours and after achievement of ethanol values less than 0.5% not fully fermented beer is brought out from section 6 and supply to decanter 8. The choice of value of the remained ethanol in beer in each particular case is influenced with many factors such as: quality of yeast, physical and chemical parameters of beer itself, operating conditions of ethanol stripping etc; the criteria are quantity of physiologically active yeast in not fully fermented beer and power consumption on removal of the remained ethanol. Optimum limiting value of the remained ethanol of less than 0.5% at which the demanded concentration of physiologically active yeast left in beer is provided on the one hand and the necessary high content of dry substances in the deposit for their further simplified utilizing is reached on the other hand was discovered on the basis of experimental data and out of operational experience. The beer which is brought out should contain a significant amount of physiologically active yeast thereby. Separation of centrifuge effluent from the deposit is carried out in the decanter 8 and concentration of active yeast in centrifuge effluent and concentration of dry substances in the deposit is raised thereby. The deposit with already great value of the dry substances content goes on technological purpose and centrifuge effluent is supplied into the storage tank 9 and further goes to preparatory vessel through the return circuit 10. Presence of a significant amount of active yeast in the centrifuge effluent allows to reduce, and even temporarily to stop, supply of yeast for fresh wort fermentation and to use more fully the working yeast thereby.

Thus, at work with initial beer with optimum low content of dry substances the decantation process raises concentration of dry substances in a deposit that simplifies its utilising and centrifuge effluent return to the stage of initial beer preparation reduces the yeast consumption and provides fuller use of working yeast that reduces the general power consumption on the ethanol production process.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of producing ethanol comprising the stage of initial beer preparation, its heating and continuous fermentation and continuous stripping of hydroalcoholic vapours and carbon dioxide carried out at the lowered pressure with subsequent tapping of exhausted beer and return of its part to the stage of initial beer preparation, in the process of tapping the beer being exposed to decantation with centrifuge effluent emission which is directed to the stage of initial beer preparation.

2. The method of claim 1, wherein the content of ethanol in beer is monitored during the stripping process and after achievement of ethanol values less than 0.5% the beer is brought out.
